(19) United States
(12) Patent Application Publication
(10) Pub. No.: US 2013/0298435 A1
(43) Pub. Date: Nov. 14, 2013

(54) NESTED LABEL FOR DISPLAYING INFORMATION ON A CONTAINER AND METHOD OF SAME

(71) Applicant: THOMAS J. SILVANO, Little Falls, NJ (US)

(72) Inventor: THOMAS J. SILVANO, Little Falls, NJ (US)

(21) Appl. No.: 13/861,163

(22) Filed: Apr. 11, 2013

Related U.S. Application Data
(60) Provisional application No. 61/644,001, filed on May 8, 2012.

(51) Int. Cl. G09F 3/00

(52) U.S. Cl. CPC G09F 3/0289
USPC 40/638; 156/277; 156/230

(57) ABSTRACT

A system and method for labeling containers requiring large amounts of information to be printed thereon using an improved nested label that is reduced in length. The nested label has a first edge, a base layer extending from the first edge, and a top layer positioned above the base layer and extending from the first edge. The base layer includes a rear surface having a substantially permanent pressure sensitive adhesive coating for adhering to the outside surface of the container and a front surface having a release coating. The top layer has a rear surface having a substantially permanent pressure sensitive adhesive coating and a front surface. The top layer is wrapped on top of the base layer from the first edge to a first position covering the base layer.

### CROSS-REFERENCE TO RELATED APPLICATION

This application claims the benefit of provisional patent application Ser. No. 61/644,001 filed in the United States Patent and Trademark Office on May 8, 2012.

### BACKGROUND OF THE INVENTION

1. Field of the Invention

This invention relates generally to labeling systems, and more particularly to a system and method for labeling containers requiring large amounts of information to be printed thereon using an improved label that is reduced in length.

2. Description of the Related Art

Small plastic containers of the type used for pharmaceutical products are labeled with ingredients, instructions, side effects, warnings and the like, in a variety of different ways. Commonly, adhesive labels are utilized which affix to the containers directly and contain a large amount of necessary written information. Basic labels wrap a maximum of 360° around the circumference of a bottle. However, to provide for increased space for written information, the length of the labels are often extended beyond the point of 360°. Sometimes, the length of the label can extend beyond the standard circumference of the bottle up to two times (720°) or three times (1080°) the circumference, making it necessary to wrap the label around the bottle two or three times respectively.

Currently, a single ply label is printed on two sides and wraps around a container multiple times. Increasing efficiency in the method of applying the labels to a container is dependent upon the number of rotations of the container. Increasing the length of the label under the prior art methods substantially increases the amount of time required to apply a label to a container. The more rotations the less efficient the label application line speed is, thus the greater amount of time required to apply the label. In particular, when the label is wrapped around the circumference of a container once, or 360°, optimum label application line speed is achieved. By wrapping a label around the circumference of a container twice, or 720°, the line speed is decreased by 50%. Similarly, wrapping a label around the circumference of a container three times, or 1080°, the line speed is decreased by 66%.

By utilizing the system and method of the present invention, one is able to maintain the informational requirements of a larger circumference wrap, while reducing the length of the label size. A label containing informational requirements of the prior art 1080° is now achieved with a nested label of the present invention, wrapped around a container 720°. By decreasing the rotation of the container 360° and still providing the informational requirements, the production line efficiency of the present invention is increased 33%.

While the prior art units may be suitable for the particular purpose employed, or for general use, they would not be as suitable for the purposes of the present invention as disclosed hereafter.

It is, therefore, a primary object of the present invention to provide an improved label that is reduced in length for labeling containers requiring large amounts of information to be printed thereon.

It is another object of the present invention to increase production output on label manufacturing lines by reducing the total length of a label, while still providing the same amount of area for receiving printed information as existing larger labels provide.

### BRIEF SUMMARY OF THE INVENTION

In accordance with one aspect of the present invention, nested label is provided for wrapping around an outside surface of a container. The nested label includes a base layer having a front surface having printed information thereon and a rear surface. The front surface includes a first area having a release coating and a second area free of the coating. The nested label includes a top layer having a front surface and a rear surface, both having printed information thereon, and the rear surface having a substantially permanent pressure sensitive adhesive coating. The rear surface of the printed top layer is positioned adjacent the front surface of the printed base layer to enable the printed top layer to releasably adhere to the first area of the front surface of the printed base layer.

The front surface of the top layer of the nested label has a release coating.

The printed top layer of the nested label is permanently adhered to the second area of the front surface of the printed base layer.

The base layer of the nested label has a substantially permanent pressure sensitive adhesive rear surface for adhering to the outside surface of the container.

The container has a lid such that a portion of the rear surface of the base layer adheres to the lid of the container.

In accordance with an additional embodiment method of creating a nested label is provided having a top layer and a base layer for wrapping around an outside surface of a container. The layers include information for a consumer thereof. First, printing information on a front surface of the base layer. Then applying a release coating to a first area of the printed front surface of the base layer. Then, printing information on both a front and a rear surface of the top layer. Then, applying a substantially permanent pressure sensitive adhesive coating to the rear surface of the printed top layer. Then, stacking together the rear surface of the printed top layer with the front surface of the printed base layer to enable the printed top layer to releasably adhere to the first area of the front surface of the printed base layer.

The method further includes applying a release coating to the printed front surface of the top layer.

The base layer includes a rear surface having a substantially permanent pressure sensitive adhesive coating and the method further includes adhering the rear surface of the base layer to the outside surface of the container.

The container has a lid and the method further includes adhering a portion of the rear surface of the base layer to the lid of the container.

The method further includes creating a repeating pattern of base layers on a continuous spool of releasable backing material.

The method further includes die cutting the base layer, die cutting the top layer, and die cutting the nested label.

In accordance with an additional embodiment method for displaying information on a container having an outside surface and lid is provided. The method includes providing a nested label having a first edge, a base layer extending from the first edge, and a top layer positioned above the base layer and extending from the first edge. The base layer includes a rear surface having a substantially permanent pressure sensitive adhesive coating and a front surface having a release coating. The top layer has a rear surface having a substantially permanent pressure sensitive adhesive coating and a front surface. The top layer is wrapped from the first edge to a first position covering the base layer, such that the substantially permanent pressure sensitive adhesive rear surface of the top layer interacts with the release coating on the front surface of the base layer to selectively hold the top layer in the first position.

The top layer has a distal end having a tab and the method further includes peeling the top layer back from the base layer by the tab on the distal end to a second position uncovering the base layer.

The method further includes printing information on both sides of the top layer and on the front surface of the base layer.

The method further includes adhering the rear surface of the base layer around the outside surface of the container.

The method further includes adhering a portion of the rear surface of the base layer around the lid of the container.

### BRIEF DESCRIPTION OF THE SEVERAL VIEWS OF THE DRAWINGS

To these and to such other objects that may hereinafter appear, the present invention relates to a system and method for labeling containers requiring large amounts of information to be printed thereon using an improved label that is reduced in length as described in detail in the following specification and recited in the annexed claims, taken together with the accompanying drawings, in which like numerals refer to like parts in which:

FIG. 1 is a perspective view of the nested label affixed to the outside surface of a cylindrical container in accordance with the present invention;

FIG. 2 is a perspective view of the nested label in a first position in accordance with the present invention including information about a medicine;

FIG. 3 is a perspective view of the nested label in a second position in accordance with the present invention including information about a medicine;

FIG. 4 is a perspective view of a spool of material containing a line of nested labels in accordance with the application of the present invention;

FIG. 5 is a perspective view of the nested label affixed to the container in accordance with the present invention shown in FIG. 1; and

FIG. 6 is a top plan view of the nested label in accordance with the present invention shown in FIG. 3 in the second position.

To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims.

### DETAILED DESCRIPTION OF THE INVENTION

The present invention is directed to a system and method for labeling containers requiring large amounts of information to be printed thereon using an improved label that is reduced in length. Preferably, the present invention is used on small plastic containers of the type used for pharmaceutical products.

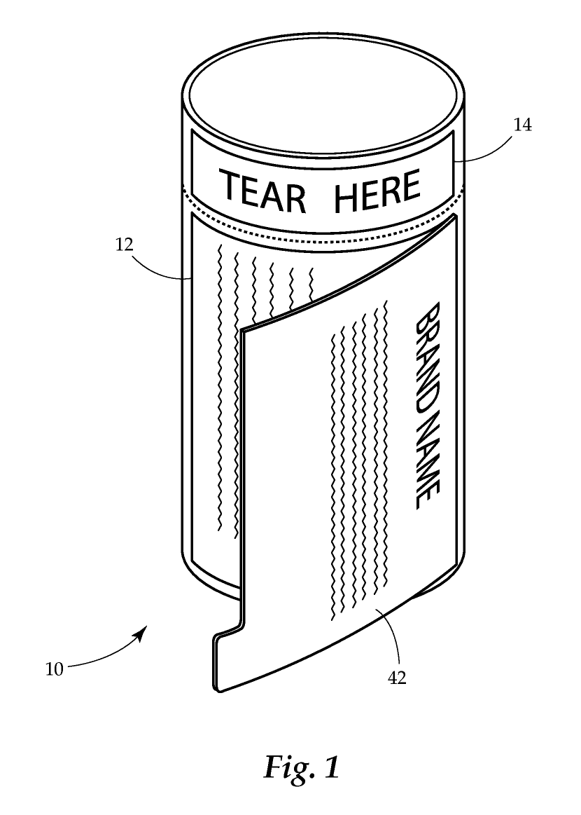

FIG. 1 illustrates a container 10, and specifically a cylindrical bottle for holding pharmaceutical items therein. The container 10 commonly holds medication in the form of pills or tablets of the type found in drug stores and supermarkets. The container 10 has an outside surface 12 and includes a twist off lid 14.

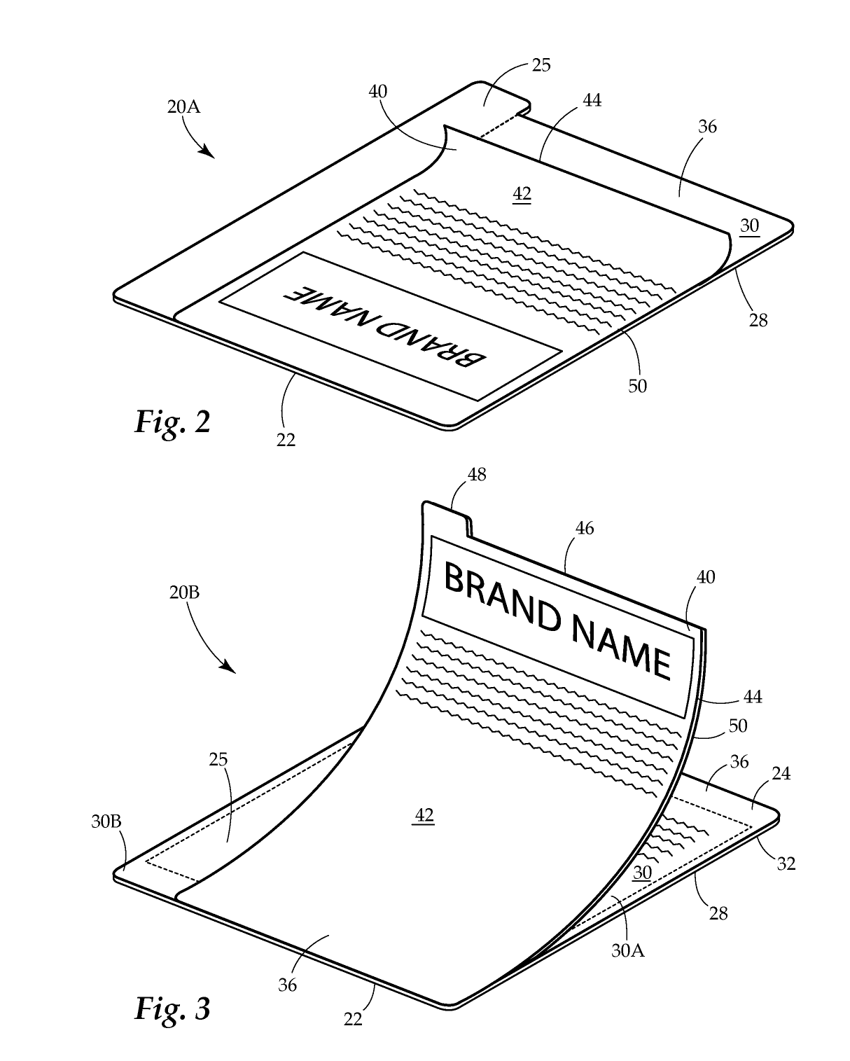

FIG. 2 illustrates a nested label 20 for wrapping around, and adhering to, the outside surface 12 of the container. The nested label 20 may also wrap around and adhere to portions of the lid 14. When there are concerns with tampering or spoiling of goods within the container, safety lids 12 may be used. In these circumstances, the nested label 20 may include a safety seal 25 to cover a portion of the lid 12 to eliminate tampering with or destroying the contents.

The nested label 20 includes a first edge 22. The first edge 22 is defined along a common plane by the coupling of a base layer 24 underneath a top layer 40. The base layer 24 extends from the first edge 22 and has a rear surface 28 and a front surface 30. The base layer 24 may also include the safety seal portion 25, removably attached thereto. The front surface 30 includes a first area 30A and a second area 30B. The rear surface 28 contains a substantially permanent pressure sensitive adhesive coating 32 for adhering the label 20 to the container 10. The first area 30A of the front surface 30 includes a release coating 36, while the second area 30B of the front surface 30 is free of said coating. The front surface 30 contains printed information thereon relative to the contents of the container 10. Most commonly, the printed information on the base and top layers 24, 40 pertains to ingredients, warnings, side effects, instructions for use and storage of medications within the container 10.

The top layer 40 is positioned above the base layer 24 and similarly extends from the first edge 22 to a distal end 46 having a tab 48, such that the base layer 24 is sandwiched or nested between the container 10 and the top layer 40 while in a first position 20A. The top layer 40 has a front surface 42 and a rear surface 44. Both the front and rear surfaces 42, 44 contain printed information thereon relative to the contents of the container 10. The rear surface 44 contains a substantially permanent pressure sensitive adhesive coating 50, which in the first position shown in FIG. 2, adheres to the release coating 36 on the front surface of the base layer 24.

FIG. 3 illustrates the nested label 20 in a second position 20B wherein the release coating 36 on the base layer 24 allows the top layer 40 to peel back from the base layer 24 by the tab 48 on the distal end 46 to a second position uncovering at least a portion of the base layer 24. Thus allowing a user to read printed information contained on the rear surface 44 of the top layer 40 and the front surface 30 of the base layer 24.

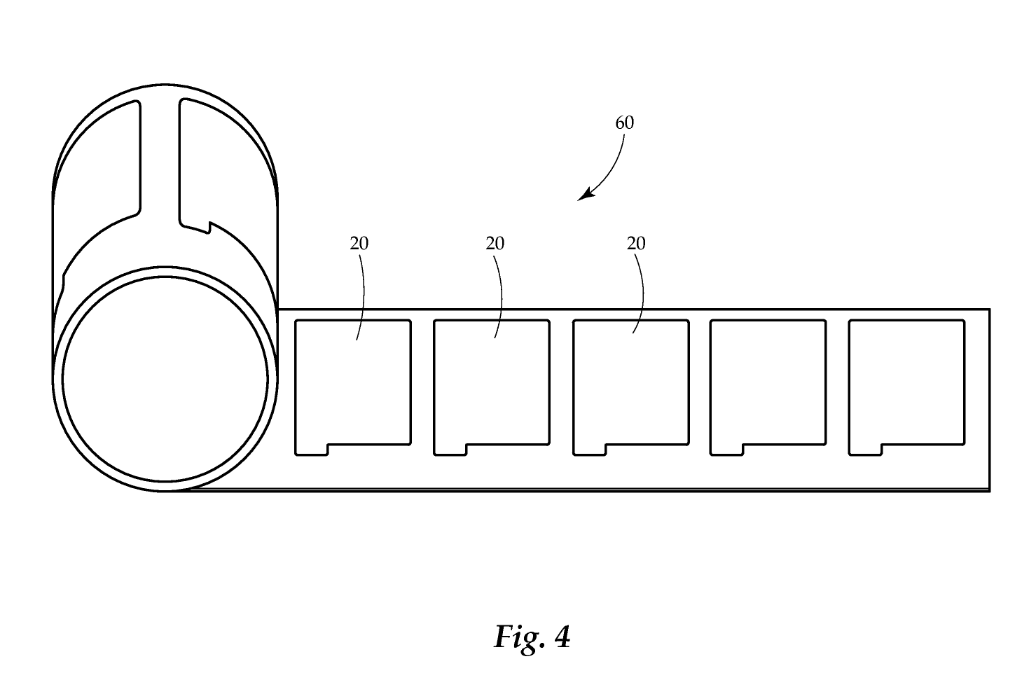

FIG. 4 illustrates a spool or web of material 60 containing a line of nested labels 20 thereon. Preferably, a line of base layers 24 and top layers 40 are each produced on separate webs of material before being combined to form the nested label 20. In particular, the base layer 24 is produced in a repeating pattern along a first web of material by first printing information on the front surface 30 of the base layer 24. Then, a release coating 36 is applied to the first area 30A of the printed front surface 30 of the base layer 24. The base layer 24 is then die cut and the excess material is removed, leaving the base layer 24 on a continuous web. Die cutting also creates the perforated safety seal 25, which is part of the base layer 24 and affixes over or around the lid 14. The seal 25 is easily ripped off from the base layer 24 at the perforation, when a user twists open the lid of the container 10 for the first time, thus providing that the contents of the container have not been tampered with after packaging. Next, the top layer 40 is produced in repeating pattern along a second web of material by printing information on both the front and rear surfaces 42, 44 of the top layer 40. Then, a substantially permanent pressure sensitive adhesive coating 50 is applied to the rear surface 44 of the printed top layer 40 to adhere the top layer 40 to the base layer 24. Finally, the rear surface 44 of the printed top layer 40 is stacked on top of the front surface 30 of the printed base layer 24 to form the nested label 20. The label 20 is then die cut again with the base layer 24 underneath the top layer 40 to produce the final nested label 20. The top layer 40 is able to releasably adhere to the first area 30A of the front surface of the base layer 24, while being more permanently affixed to the second area 30A of the base layer 24 defining the first edge 22. The second area 30B of the base layer 24 is free of the release coating 36, thus allowing the substantially permanent pressure sensitive adhesive coating 50 at the first edge 22 on the top layer 26 to non-removably adhere to the base layer 24.

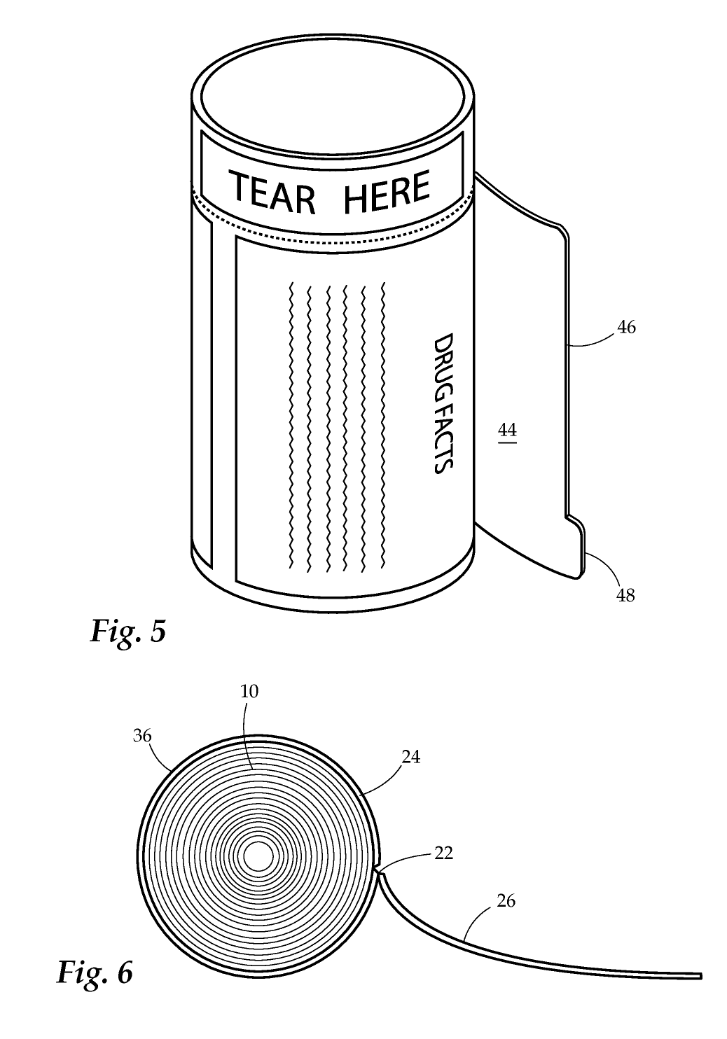

FIGS. 5 and 6 illustrate the nested label 20 affixed around the outside surface 12 of the container 10. When the nested label 20 is affixed to the container 10 the base layer 24 is applied directly to the outside surface 12 of the container, while the top layer 40 is positioned thereon and simultaneously wrapped around the container 10. In one embodiment, shown in FIG. 5, the top layer 40 is of equal or lesser length than the base layer 24, and thus once the base layer 24 is affixed to the container the top layer 40 is simultaneously fully applied. In another embodiment, wherein the top layer 40 is considerable longer than the base layer 24, shown in FIGS. 3. and 6, the additional length of the top layer 40 must continue to be applied by wrapping around the container 10 on top of itself after the base layer 24 is applied. Overall, the nested label 20 is applied more quickly by eliminating at least one rotation of the container 10 during application.

A user interested in reading the printed information contained on the base and top layers 24, 40 begins by reading the front surface 42 of the top layer 40 wrapped around the container 10. Then, the user peels back the top layer 40 from the base layer 24 by the tab 48 on the distal end 46, and continues reading the printed information contained on the rear surface 44 of the top layer 40. Once the top layer 40 is substantially unwrapped from the base layer 24, but for the affixed second area 30B at the first edge 22, the user may continue reading the information printed on the front surface 30 of the base layer 24. Labels containing a large amount of printed information may require that the top layer 40 wrap around the container 10 more than once, such that the top layer 40 covers over itself. In these embodiments, the front surface 42 of the top layer 40 contains the release coating 36, for allowing the top layer 26 to peel back from itself when unwrapped from around the container 10 multiple times.

In conclusion, herein is presented system and method for labeling containers requiring large amounts of information to be printed thereon using an improved nested label that is reduced in length. The invention is illustrated by example in the drawing figures, and throughout the written description. It should be understood that numerous variations are possible, while adhering to the inventive concept. Such variations are contemplated as being a part of the present invention. While one preferred embodiments of the present invention has been disclosed for purposes of illustration, it is obvious that many modifications and variations could be made thereto. It is intended to cover all of those modifications and variations, which fall within the scope of the present invention as defined by the following claims.

We claim:

1. A nested label for wrapping around an outside surface of a container, comprising:
a base layer having a front surface having printed information thereon and a rear surface, wherein the front surface includes a first area having a release coating and a second area free of said coating; and
a top layer having a front surface and a rear surface, both having printed information thereon, and said rear surface having a substantially permanent pressure sensitive adhesive coating,
wherein said rear surface of said printed top layer is positioned adjacent said front surface of said printed base layer to enable the printed top layer to releasably adhere to the first area of the front surface of the printed base layer.

2. The nested label of claim 1 wherein the front surface of the top layer has a release coating.

3. The nested label of claim 1 wherein the printed top layer is permanently adhered to the second area of the front surface of the printed base layer.

4. The nested label of claim 1 wherein the base layer has a substantially permanent pressure sensitive adhesive rear surface for adhering to the outside surface of the container.

5. The nested label of claim 4 wherein the container has a lid such that a portion of the rear surface of the base layer adheres to the lid of the container.

6. A method of creating a nested label having a top layer and a base layer for wrapping around an outside surface of a container, wherein said layers include information for a consumer thereof, the steps comprising:
a. printing information on a front surface of the base layer;
b. applying a release coating to a first area of the printed front surface of the base layer;
c. printing information on both a front and a rear surface of the top layer;
d. applying a substantially permanent pressure sensitive adhesive coating to the rear surface of the printed top layer; and
e. stacking together the rear surface of the printed top layer with the front surface of the printed base layer to enable the printed top layer to releasably adhere to the first area of the front surface of the printed base layer.

7. The method of claim 6 further comprising the step of applying a release coating to the printed front surface of the top layer.

8. The method of claim 6 wherein the base layer includes a rear surface having a substantially permanent pressure sensitive adhesive coating and further comprising the step of adhering the rear surface of the base layer to the outside surface of the container.

9. The method of claim 8 wherein the container has a lid and further comprising the step of adhering a portion of the rear surface of the base layer to the lid of the container.

10. The method of claim 6 further comprising the step of creating a repeating pattern of base layers on a continuous spool of releasable backing material.

11. The method of claim 6 further comprising the steps of die cutting the base layer; die cutting the top layer; and die cutting the nested label.

12. A method for displaying information on a container having an outside surface and lid, the steps comprising:
a. providing a nested label having a first edge, a base layer extending from said first edge, and a top layer positioned above said base layer and extending from said first edge, wherein:
the base layer includes a rear surface having a substantially permanent pressure sensitive adhesive coating and a front surface having a release coating, and
the top layer has a rear surface having a substantially permanent pressure sensitive adhesive coating and a front surface; and
b. wrapping the top layer from the first edge to a first position covering the base layer, wherein the substantially permanent pressure sensitive adhesive rear surface of the top layer interacts with the release coating on the front surface of the base layer to selectively hold the top layer in said first position.

13. The method of claim 12 wherein the top layer has a distal end having a tab and further comprising peeling the top layer back from the base layer by the tab on the distal end to a second position uncovering the base layer.

14. The method of claim 12 further comprising printing information on both sides of the top layer and on the front surface of the base layer.

15. The method of claim 12 further comprising adhering the rear surface of the base layer around the outside surface of the container.

16. The method of claim 15 further comprising adhering a portion of the rear surface of the base layer around the lid of the container.
